(19) United States
(12) Patent Application Publication
(10) Pub. No.: US 2007/0147909 A1
(43) Pub. Date: Jun. 28, 2007

(54) Rotation driving apparatus, transfer unit, and image forming apparatus

(76) Inventor: Masahiko Katoh, Yokohama-shi (JP)

Correspondence Address: COOPER & DUNHAM, LLP, 1185 AVENUE OF THE AMERICAS, NEW YORK, NY, 10036, US

(21) Appl. No.: 11/642,374

(22) Filed: Dec. 19, 2006

(30) Foreign Application Priority Data
Dec. 19, 2005 (JP) 2005-365078

(51) Int. Cl. G03G 15/01

(52) U.S. Cl. 399/302; 399/303

(57) ABSTRACT

A rotation driving apparatus is employed in a transfer unit for transferring and superimposing different color images formed on a plurality of image formation sections arranged side by side on a recordation medium carried on a belt transfer member. The rotation driving apparatus includes a plurality of rollers winding the belt transfer member, a roller state tightener for applying tension to the belt transfer member, and a driving system including a motor and a gear for driving the plurality of rollers.

### TECHNICAL FIELD

The present application relates to a transfer unit and a rotation driving apparatus for driving the transfer unit included in an image forming apparatus such as an electrophotographic laser printer, a laser plotter, a copier, a facsimile, and a multifunction machine including functions of these devices, and in particular, to a rotation driving apparatus capable of reducing vibration caused in a transfer unit, a transfer unit including the rotation driving apparatus, and an image forming apparatus capable of obtaining a high quality image with the transfer unit while reducing vibration.

### BACKGROUND ART

Recently, color documents are rapidly becoming popular in offices, and accordingly, an image forming apparatus such as a copier, a printer, a facsimile, etc. handling such documents is also rapidly gaining popularity. Such color image forming apparatuses tend to be high quality and high speed as office work becomes sophisticated.

In response to such demand, various tandem type color image forming apparatuses, which employ yellow, magenta, cyan, and black image formation sections capable of forming and superimposing different color images on one of recording medium carried by a transfer member and an intermediate transfer member, have been proposed and are practically manufactured.

As a disincentive for making a high quality image in a color image forming apparatus that employs an electrophotographic system like a tandem type color image forming apparatus, undesirable phenomena, such as jitter, banding, etc., often occur in conventional color image forming apparatuses. Especially, since image quality is increasingly improved due to introduction of digital technology, positional precision of laser wiring is greatly needed per line. A change in speed caused by vibration of a rotation system is one example of the factors that adversely affect the precision. Accordingly, decreasing such vibration becomes important in developing a product capable of creating a high quality image.

As a conventional technology directed to decreasing vibration in a rotation system, Japanese Patent Application Laid Open No. 10-333385 is exemplified. Specifically, a color image forming apparatus includes a driving apparatus employing a shaft penetrating type motor having a shaft gear at one end of the shaft. An image bearer and an intermediate transfer member are driven by a gear train meshing with the shaft gear. The color image forming apparatus includes a dynamic damper or a flywheel connected to the other end of the shaft. Since amplification of vibration caused by harmonic vibration of the motor is suppressed by the dynamic damper or the flywheel, vibration is also suppressed on the image bearer, thereby disturbance in latent image formation on the surface is prevented.

Japanese Patent Application Laid Open NO. 9-222826 is also directed to preventing vibration amplification in a color image forming apparatus.

Specifically, inertial mass of an inertial member and a number of rotation or teeth of a gear of the rotation system is determined so that eccentricity of the rotation driving apparatus having gears and a frequency of speed change caused by meshing of the gears can fall within a damping region which appears in a frequency response of the rotation driving apparatus.

In the tandem type color image forming apparatus, a color image is typically created by superimposing different color toner images formed on a plurality of image formation sections on a transfer sheet or a belt state intermediate transfer member (e.g. intermediate transfer belt) or the like, each carried and conveyed by a belt state transfer member (e.g. transfer belt). Vibration of a rotation system in such an image forming apparatus is caused by twisting vibration, determined by inertia or rigidity of a shaft, and elongation and string vibration of a belt or the like. It is generally recognized that visible sensitivity in relation to a spatial frequency is noticeable in a range of from about 0.3 to about 2 (line/mm) due to visual capability of human being. When considering this together with rotation speed of a photoconductive member in the image formation section, it is necessary to avoid vibration caused in a frequency range of from a few Hz to a few hundreds Hz.

As an exemplary rotation driving system of a transfer unit of an image forming apparatus, the following configuration has been proposed. Specifically, a belt serving as a transfer belt or an intermediate transfer belt, a plurality of rollers (e.g. driving and driven rollers) winding the belt, a roller state tightener for applying tension to the belt wound around the rollers, a driving device such as a motor for rotating and driving one of the plurality of rollers (e.g. driving roller) to convey the belt, and a driving transmission system are employed.

However, such a configuration causes vibration due to motor rotation and meshing of the gear and the belt of the driving transmission, and thereby creating a change in surface speed of the belt. Specifically, when a natural vibration frequency (that creates string vibration on the belt) almost accords with an excitation frequency of a driving system, the belt vibrates harmonically. Such belt harmonic vibration causes a change in the surface speed of the belt, and leads to deterioration of image quality as well as creation of noise. Further, when the surface speed of the belt changes at a prescribed frequency, an image transferred onto a recordation medium or an intermediate transfer belt has dark and light portions at an interval, thereby density unevenness is created.

There is no need for an improved rotation driving apparatus which overcomes such problems.

### SUMMARY

The present disclosure provides a novel rotation driving apparatus. Such a novel rotation driving apparatus is employed in a transfer unit for transferring and superimposing different color images formed on a plurality of image formation sections arranged side by side on a recordation medium carried on a belt transfer member. The rotation driving apparatus includes a plurality of rollers winding the belt transfer member, a roller state tightener for applying tension to the belt transfer member, and a driving system including a motor and a gear for driving the plurality of rollers. Further, the following formula is established, wherein T represents tension of the belt transfer member, m represents mass of the belt transfer member per unit length, L represents a length of the belt transfer member between the two rollers or one of the two rollers and the tightener, fm represents a rotation frequency of the motor, and n represents an order (or degree) number of a string vibration mode included in a transfer belt:
(n²T)/(2L²m)<fm²
(n=1, 2, 3).

In another embodiment, the following formula is established, wherein T represents tension of the belt transfer member, m represents mass of the belt transfer member per unit length, L represents a length of the belt transfer member between the two rollers or one of the two rollers and the tightener, z represents a number of gear teeth, s represents a rotation frequency of the gear per second, and n represents an order (or degree) number of a string vibration mode included in a transfer belt:
(n²T)/(2L²m)<z²s²
(n=1, 2, 3)

In yet another embodiment, a number of the tightener is two or more, and a string vibration occurrence frequency of the belt transfer member is out of a visualization space frequency.

In yet another embodiment, a tightener moving device is provided to move the tightener both in parallel and perpendicular to a belt stretching direction of the belt transfer member.

In yet another embodiment, a string vibration detection sensor is provided to detect string vibration. The sensor is arranged in the vicinity of the surface of the belt transfer member. A tightener moving control device is provided to control the tightener moving device to move the tightener in a prescribed position in accordance with a detection result of the string vibration detection sensor.

In yet another embodiment, the string vibration detection sensor includes a microphone.

In addition, the rotation driving apparatus can be included in a transfer apparatus which transfers and superimposes different color images formed on the plurality of image formation sections arranged side by side on a recording medium.

Further, an image forming apparatus can comprise at least two image formation sections arranged side by side and configured to form different color images, respectively, and the above-mentioned transfer apparatus which includes the rotation driving apparatus.

### BRIEF DESCRIPTION OF DRAWINGS

A more complete appreciation of the present disclosure and many of the attendant features, and advantages thereof will be readily obtained as the same becomes better understood by reference to the following detailed description when considered in connection with the accompanying drawings, wherein:

FIG. 1 illustrates a perspective view of an outline of a configuration of an exemplary rotation driving apparatus included in a transfer unit;

FIG. 2 illustrates a notional representation of an exemplary vibration mode of a string when vibrating in a direction perpendicular to a tension applying direction as to a belt suspended by two fulcrums;

FIG. 3 illustrates an exemplary graph showing vibration transmissibility when damping ratio is 0.01;

FIG. 4 illustrates an outline of a configuration of an exemplary rotation driving apparatus employing a plurality of tighteners in a transfer belt driving system;

FIG. 5 illustrates an outline of a configuration of an exemplary rotation driving apparatus capable of moving a tightener in a direction in parallel to a transfer belt stretching direction;

FIG. 6 illustrates an outline of a configuration of an exemplary rotation driving apparatus capable of moving a tightener in a direction perpendicular to a transfer belt stretching direction;

FIG. 7 illustrates an outline of a configuration of an exemplary rotation driving apparatus including a driving apparatus for moving the tightener horizontally, a string vibration detection sensor arranged in the vicinity of the surface of the transfer belt, and a tightener driving system control apparatus; and

FIG. 8 illustrates an outline of a configuration of an exemplary color image forming apparatus according to an exemplary embodiment of the present disclosure.

### DESCRIPTION OF PREFERRED EMBODIMENTS

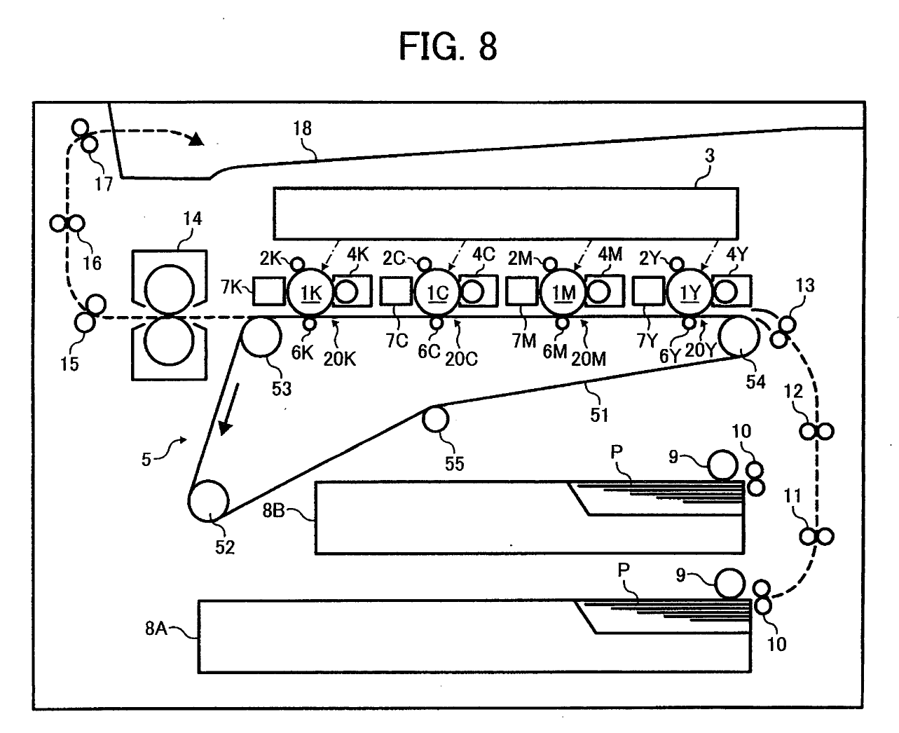

Referring now to the drawings, wherein like reference numerals and marks designate identical or corresponding parts throughout several figures, in particular in FIG. 8, an configuration of a color image forming apparatus of a tandem type color printer according to one embodiment of the present disclosure is schematically illustrated. The color image forming apparatus includes four image formation units of a yellow color image formation unit 20Y for forming a yellow image, a magenta color image formation unit 20M for forming a magenta image, a cyan color image formation unit 20C for forming a cyan image, and a black color image formation unit 20K for forming a black image. Each of the four image formation units 20Y, 20M, 20C, and 20K is arranged side by side at a prescribed interval.

A transfer unit 5 including a endless transfer belt 51 is arranged as a transfer member beneath the respective yellow to black image formation units 20Y, 20M, 20C, and 20K through the respective transfer stations so as to electro-statically absorb and convey a recordation medium P such as a transfer sheet. The transfer belt 51 is driven by a plurality of rollers including the driving and driven rollers 52 to 54 in a direction as shown by an arrow. A tightener 55 is arranged between the driving and driven rollers 52 and 54.

These four image formation units 20Y to 20K are substantially equivalently configured and form four toner images one after another, respectively, as mentioned earlier. More specifically, these image formation units 20Y to 20K include photoconductive drums 1Y to 1K, discharging devices 2Y to 2K, an optical writing device 3, developing devices 4Y to 4K, a transfer belt 51 and transfer devices 6Y to 6K forming a transfer unit 5, and photoconductive member cleaning devices 7Y to 7K, and similar devices around the photoconductive drums 1Y to 1K, respectively.

Discharge rollers, discharge brushes, dischargers (e.g. scorotron), etc., are employed as the discharge devices 2Y to 2K, but are not limited thereto. The optical writing device 3 is a laser scanning type writing apparatus using a laser scanning optical system, and includes four light sources (e.g. a semiconductor laser) arranged corresponding to the respective photoconductive drums. Also included are an optical system for collimating light flux emitted from the respective light sources, an beam deflector for deflecting the light flux emitted from the light sources, and an optical system having a scanning use lens such as a F-theta lens, a correction lens for correcting surface tilt or the like, and a plurality of mirrors for leading the light flux deflected by the deflector to the respective photoconductive drums. Instead of the laser scanning type, the writing apparatus can be formed by combining and arranging a light emission diode array (e.g. LED array) and an imaging optical element opposing the respective photoconductive drums.

The developing devices 4Y to 4K include yellow, magenta, cyan, and black color developer of one component developer (i.e., only toner) or two-component developer (i.e., toner and carrier), developing rollers, and stirring members for stirring the developer, and similar parts. The transfer devices 6Y to 6K in the transfer unit 5 can be any one of transfer rollers, transfer brushes, and transfer chargers or the like, but are not limited thereto. The photoconductive member cleaning devices 7Y to 7K can be anyone of cleaning rollers, cleaning brushes, and cleaning blades or the like, but are not limited thereto. A charge removing member, not shown, can be arranged upon need so as to remove electricity remaining on the photoconductive drum after a transfer process.

Below the transfer unit 5, a plurality of sheet cassettes 8A and 8B accommodating recordation mediums P such as transfer sheets are arranged including sheet feeding devices such as sheet feed rollers 9 and separation rollers 10. Further, on the right side of the image forming apparatus in the drawing, a plurality of conveyance rollers 11 and 12 for conveying the recordation medium P fed from the sheet feeding cassette and a registration roller 13 for launching the recordation medium P to the transfer belt 51 in synchronism with image formation are arranged. Further, on the left side of the image forming apparatus in the drawing, a fixing device 14, a plurality of conveyance rollers 15 and 16, and an ejection roller 17 are arranged. The fixing device 14 can be a combination of a fixing roller with a heat applying device and a pressure applying roller or a combination of a fixing belt with a heat applying device and a pressure applying roller or belt or the like, but is not limited thereto.

In the above-mentioned image forming apparatus, when image formation starts, the surface of the photoconductive drums 1Y to 1K are uniformly charged by the discharge devices 2Y to 2K in the four image formation units 20Y to 20K. Laser light for image formation use is emitted from the optical writing device 3 so as to scans and exposes the photoconductive drums 1Y to 1K in accordance with image information with respective colors, thereby creating latent images thereon. The latent images formed on the surfaces of the respective photoconductive drums 1Y to 1K are developed by the developing devices 4Y to 4K with yellow to black toner, thereby becoming visual toner images. These visual toner images are transferred and superimposed by the transfer devices 6Y to 6K on a recordation medium P such as a transfer sheet held on a transfer belt 51 after being fed from one of the sheet cassettes 8A and 8B and passing through the registration roller.

The recordation medium P with the superimposition of mono color toner images is then separated from the transfer belt 51, and receives fixing processing from a fixing device 14, thereby the color image is fixed thereon. Then, the transfer sheet is ejected onto a sheet ejection tray 18 through conveyance and ejection rollers 15 to 17. Further, toner remaining on the respective photoconductive drums 1Y to 1K after the image transfer process are removed by photoconductive member cleaning devices 7Y to 7K. Even not shown, a belt cleaning device can be arranged upon need to clean the transfer belt 51.

The above-mentioned embodiment employs the transfer belt. However, an intermediate transfer belt can be employed for the transfer belt as shown in FIG. 8. Specifically, a secondary transfer device is newly employed, and toner images are transferred and superimposed on the intermediate transfer belt from the respective photoconductive drums. The secondary transfer device transfers the superimposition of toner images onto a recordation medium at once. In such a situation, positioning of a fixing device and a conveyance route for the recordation medium are appropriately arranged different from those in FIG. 8.

Although FIG. 8 illustrates an exemplary color printer alone, the color printer is used as a copier if an original document reading apparatus such as a scanner is added. Further, by adding a processing section for image data as well as a communications function connecting to a telephone line, an optical line, and a LAN or the like, it can also be used as a facsimile or a multifunctional machine having various functions.

Now, various embodiments of an exemplary rotation driving apparatus for a transfer unit according to the present disclosure are described, wherein an intermediate transfer belt can be similarly used as a rotation member even though a transfer belt is used as one example.

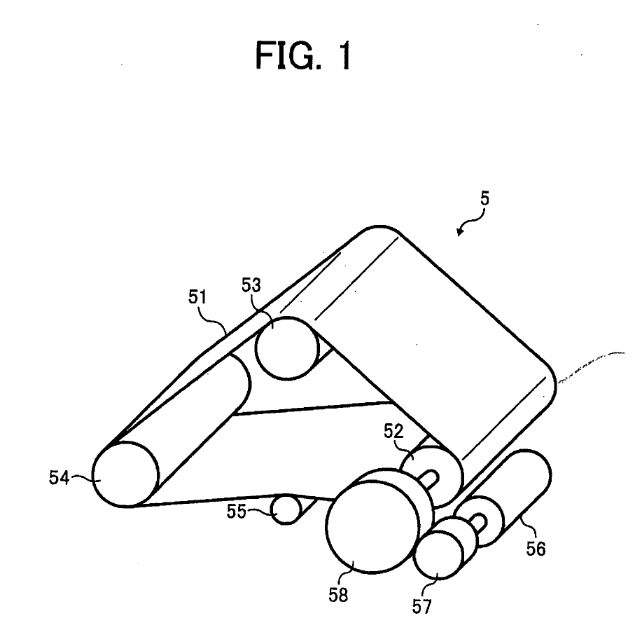

The first embodiment is now described with reference to FIG. 1. As shown, the rotation driving system includes a transfer belt 51, a plurality of rollers 52 to 54 winding the transfer belt 51, a roller shape tightener 55 for applying tension to the transfer belt, and a driving device for driving one of the plurality of rollers 52 to 54 (e.g. driving roller 52) so as to convey the transfer belt 51. Such a driving device mainly includes a driving motor 56 and a plurality of gears 57 and 58 serving as a drive transmission system.

The rotation driving apparatus rotates the shaft of the driving roller 52 via the gear train 57 and 58 by means of the driving motor 56, which is controlled and rotated by a drive control apparatus, not shown, and drives the transfer belt 51. In such a driving system for the transfer belt 51, string vibration of the transfer belt 51 sometimes causes a change in rotation speed and noises. The string vibration generally occurs in a direction perpendicular to that of application of tension to the transfer belt 51 suspended between two rollers or a roller and a tightener as two fulcrums.

As shown, the belt includes string vibration modes such as a first mode, a second mode, a third mode, and so on, when a frequency creating such vibration modes coincides with or is in the vicinity of that of an excitation source, string vibration occurs. A vibration transmissibility when a damping ratio is 0.01 is illustrated in FIG. 3 as a reference. As shown, the vibration transmissibility becomes maximum when a ratio between a sympathetic vibration frequency and an excitation frequency (i.e., an excitation frequency/a sympathetic vibration frequency) is one. Vibration transmission enters a dumping region when the ratio is not less than root two (√2).

In the rotation driving apparatus shown in FIG. 1, the motor 56 rotating at a rotation frequency can be one of excitation sources. Accordingly, vibration can be reduced if the ratio between a frequency of the excitation source and that causing a string vibration (i.e., an excitation frequency/a sympathetic vibration frequency) is not less than root two (√2).

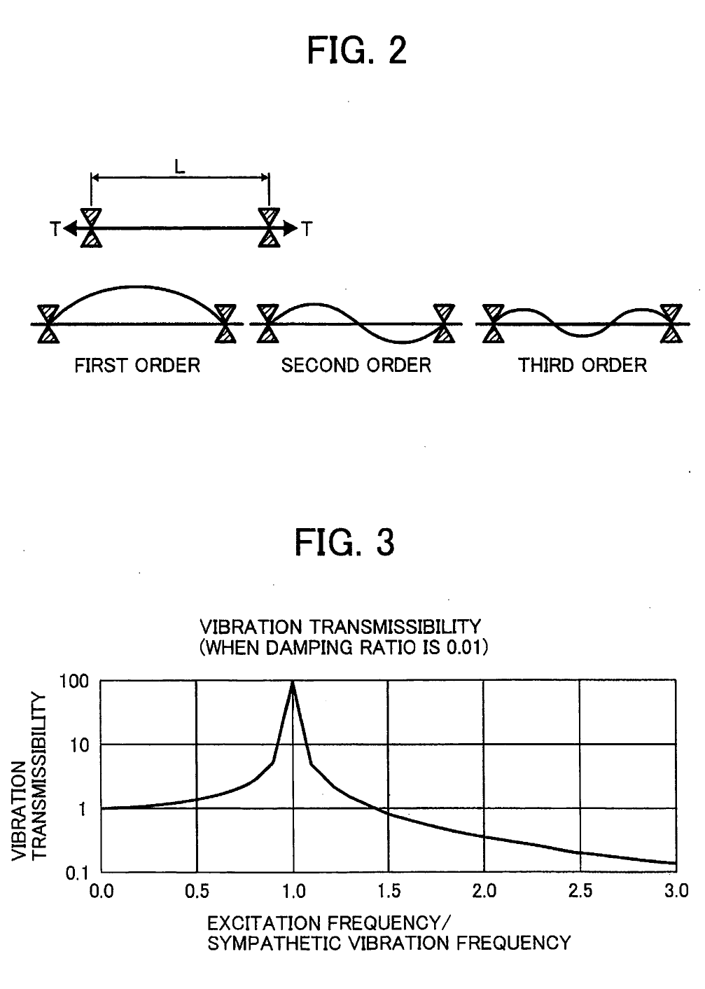

For example, a string vibration occurrence frequency (f) is calculated by the following formula when a driving system of FIG. 1 is employed, wherein T represents tension of the belt, m represents mass of the belt per unit length, L represents a length between two rollers or a roller and a tightener, and n represents an order (or degree) number of a string vibration mode included in a transfer belt as shown in FIG. 2;
f=n/2L√(T/m) (1)

Thus, a condition enabling the vibration transmissibility to be not more than one is calculated by the following formula, wherein fm represents a rotation frequency of the motor 56;
(n²T)/(2L²m)<fm²
(n=1, 2, 3) (2)

By employing a configuration to meet the above-mentioned formula, sympathetic vibration as well as string vibration caused by a motor rotation frequency can be reduced. As a result, an excellent driving system almost free from image deterioration or noises can be obtained.

Now, a second embodiment is described. The driving system for the transfer belt 51 sometimes employs gears 57 and 58 so as to decrease rotation speed of the motor 56.

Then, the gears mesh and collide with each other zs times per second as is calculated by multiplying a number of gear teeth (z) and a number of rotations of the gear per second (s). Thus, gear drive can become an excitation source. Such an excitation causes the transfer belt 51 to create string vibration and thereby deteriorating an image and generating noises. Thus, to avoid such sympathetic vibration due to a gear meshing frequency, a configuration is preferably designed so that the ratio (i.e., an excitation frequency/a sympathetic vibration frequency) falls within a vibration damping region not less than root two (√2) as calculated by the following formula;
(n²T)/(2L²m)<z²s²
(n=1, 2, 3) (3)
By meeting the above-mentioned formula, sympathetic vibration as well as string vibration caused by a gear meshing frequency can be reduced. Thereby, an excellent driving system can be obtained almost free from image deterioration or noises.

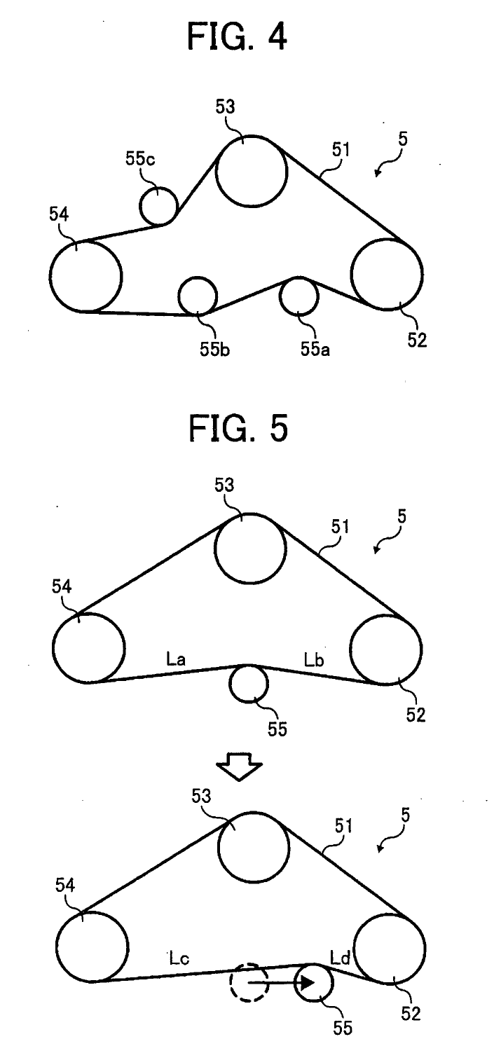

A third embodiment is now described with reference to FIG. 4. As shown, an exemplary rotation driving apparatus uses a plurality of tighteners 55a to 55c in a driving system for a transfer belt 51. As understood from the formula (1), a frequency creating string vibration relies on a length of the transfer belt 51 determined by positions of the rollers 52 to 54 as well as the tightener 55. Accordingly, simply because the number of the tightener is plural, the length of the transfer belt 51 becomes substantially shorter and a string vibration occurrence frequency becomes higher in comparison with a case when the number is only one. It is well known as to a relation between a visible sensitivity and a spatial frequency of an image that a change easily spots when a visual spatial frequency ranges from about 0.3 to about 2 (line/mm) in view of sight of human being. Considering this together with rotation speed of a photoconductive member, vibration in a frequency ranging from about few Hz to about few hundreds Hz is preferably avoided. Accordingly, human being does not recognize deterioration of an image even if there exists vibration components having a frequency outside the above-mentioned range. Utilizing this principle, while employing a plurality of tighteners 55a to 55c as well as increasing a string vibration occurrence frequency more than a visual spatial frequency, a high quality image can be seemingly obtained. Further, when the tighteners 55a to 55c contact, the transfer belt 51 receives damping and is capable of effectively suppressing influence of excitation from the motor 56 or the like. When material, such as rubber, having a high damping performance is employed for the tightener 55a to 55c, damping can be more effective.

A fourth embodiment is now described with reference to FIG. 5, wherein an exemplary rotation driving apparatus is described. Specifically, a tightener 55 is movable in a direction in parallel to an expansion direction of a transfer belt 51. As shown, by horizontally moving the tightener 55 along the transfer belt 51, a length of the transfer belt 51 defined by the rollers 52 and 54 and the tightener 55 can be readily changed from La and Lb to Lc and Ld, and accordingly, a frequency causing string vibration is changed in the same manner. That is, a frequency causing the string vibration can be adjusted only by changing a horizontal position of the tightener 55 in an instrument, such as an image forming apparatus, etc., that includes different rotation speeds of a driving system in accordance with a mode during printing. Thus, sympathetic vibration possibly created when rotation speed is different can be suppressed.

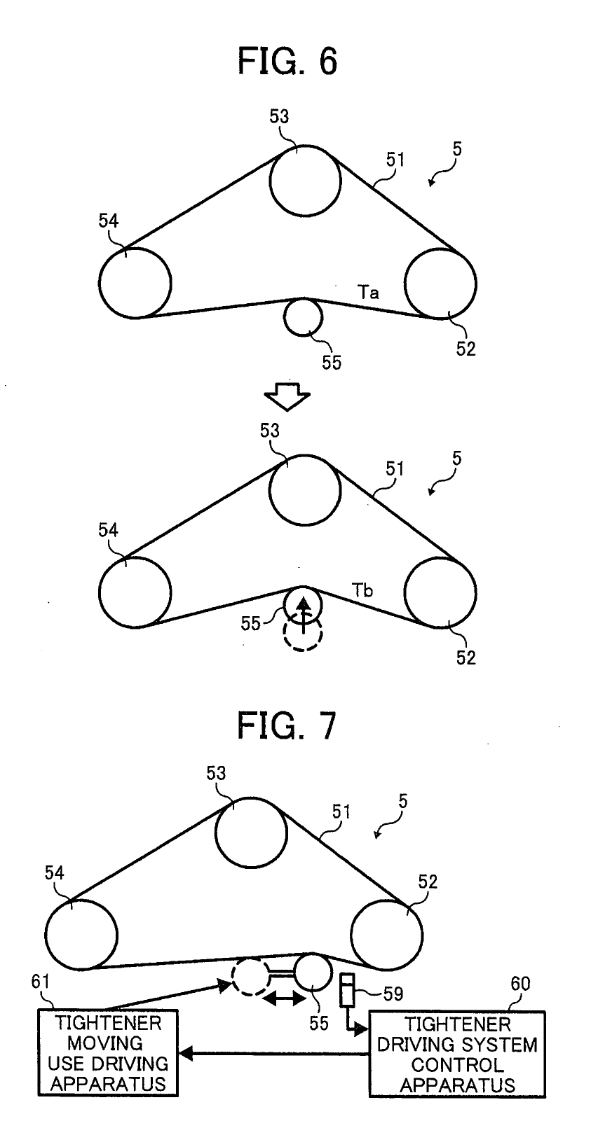

A fifth embodiment is now described with reference to FIG. 6, wherein an exemplary rotation driving apparatus is described, wherein a tightener 55 is movable in a direction perpendicular to an expansion direction of a transfer belt 51. As shown, by perpendicularly moving the tightener 55 in relation to the transfer belt 51, tension of the transfer belt 51 can be readily changed from Ta to Tb, and accordingly a frequency causing string vibration. Thereby, sympathetic vibration can be suppressed.

With reference to FIG. 7, another exemplary rotation driving apparatus is described, in which a driving apparatus 61 is employed to horizontally or perpendicularly move a tightener 55 as shown in FIG. 5 or FIG. 6. Specifically, a string vibration detection sensor 59 is arranged in the vicinity of the surface of the transfer belt, and a tightener driving system control apparatus 60 with a microcomputer or the like are employed. Now, an exemplary operation of the rotation driving apparatus is described. Initially, the string vibration detection sensor 59 detects a frequency of string vibration. Then, the tightener driving system control apparatus 60 compares the current string vibration frequency with an excitation frequency of the driving system based on the detected data. The tightener driving system control apparatus 60 then outputs an instruction to a tighter moving use driving apparatus 61 so that the condition calculated by the formula (2) or (3) can be met and the tightener 55 is moved to an appropriate position where sympathetic vibration does not occur. Such tightener moving use driving apparatus 61 can be constituted by a simple mechanism such as a combination of a small motor and a moving mechanism. By positioning the tightener 55 appropriately, sympathetic vibration can be suppressed according to various circumstances during driving.

A microphone can be used for the string vibration detection sensor 59 in the rotation driving apparatus. In such a situation, the microphone is arranged in the vicinity of a string to detect a vibration frequency based on sound created by string vibration.

The microphone can be advantageously mounted on a machine due to not only being compact, cost, and easy availability, but also non-contact in relation to the transfer belt 51 and thus ineffective to a driving system.

Now, a sixth embodiment is described with reference to FIG. 8. As shown, a transfer unit 5 of an image forming apparatus similar to that illustrated in FIG. 5 is provided including a rotation driving apparatus of any one of the first to fifth embodiments. Thus, amplification of vibration caused by sympathetic vibration can be reduced, and a high quality and low noise achieving transfer unit 5 can be obtained. For the same reason, a high quality and low noise achieving color image forming apparatus can be obtained while reducing amplification of vibration caused by sympathetic vibration.

Obviously, numerous additional modifications and variations of the present disclosure are possible in light of the above teachings. It is therefore to be understood that within the scope of the appended claims, the present disclosure may be practiced otherwise than as specifically described herein.

This application claims priority under 35 U.S.C. §119 to Japanese Patent Application No. 2005-365078, filed on Dec. 19, 2005, the entire contents of which are incorporated herein by reference.

What is claimed is:

1. A rotation driving apparatus for use in a transfer unit configured to transfer and superimpose different color images formed on at least two image formation sections arranged side by side on a recordation medium carried on one of a belt transfer member and a belt intermediate transfer member, said rotation driving apparatus comprising:
at least two rollers winding the one of the belt transfer member and the belt intermediate transfer member;
at least one roller state tightener configured to apply tension to the one the belt transfer member and a belt intermediate transfer member; and
a driving system configured to drive one of the at least two rollers, said driving system including at least a motor and a gear;
wherein the following formula is established, wherein T represents tension of the one of the belt transfer member and the belt intermediate transfer member, m represents mass of the one of the belt transfer member and the belt intermediate transfer member per unit length, L represents a length of the one of the belt transfer member and the belt intermediate transfer member between the two rollers or one of the two rollers and the tightener, fm represents a rotation frequency of the motor, and n represents an order (or degree) number of a string vibration mode included in the transfer belt;
(n²T)/(2L²m)<fm²
(n=1, 2, 3)

2. The rotation driving apparatus as claimed in claim 1, wherein a number of said roller state tightener is at least two, and wherein a string vibration occurrence frequency of the one of the belt transfer member and the belt intermediate transfer member is out of a visualization space frequency.

3. The rotation driving apparatus as claimed in claim 1, further comprising a tightener moving device configured to move the roller state tightener both in parallel and perpendicular to a belt stretching direction of the one of the belt transfer member and the belt intermediate transfer member.

4. The rotation driving apparatus as claimed in claim 3, further comprising:
a string vibration detection sensor configured to detect string vibration, said sensor being arranged in the vicinity of the surface of the one of the belt transfer member and the belt intermediate transfer member; and
a tightener moving control device configured to control the tightener moving device to move the roller state tightener in a prescribed position in accordance with a detection result of the string vibration detection sensor.

5. The rotation driving apparatus as claimed in claim 4, wherein said string vibration detection sensor includes a microphone.

6. A transfer apparatus configured to transfer and superimpose the different color images formed on the at least two image formation sections arranged side by side on the recording medium carried on one of the belt transfer member and the belt intermediate transfer member, said transfer apparatus comprising a rotation driving apparatus as claimed claim 1.

7. An image forming apparatus comprising:
at least two image formation sections arranged side by side and configured to form different color images, respectively; and
a transfer apparatus as claimed in claim 6.

8. A rotation driving apparatus for use in a transfer unit configured to transfer and superimpose different color images formed on at least two image formation sections arranged side by side on a recordation medium carried on one of a belt transfer member and a belt intermediate transfer member, said rotation driving apparatus comprising:
at least two rollers winding the one of the belt transfer member and the belt intermediate transfer member;
at least one roller state tightener configured to apply tension to the one of a belt transfer member and the belt intermediate transfer member; and
a driving system configured to drive one of the at least two rollers, said driving system including at least a motor and a gear;
wherein the following formula is established, wherein T represents tension of the one of the belt transfer member and the belt intermediate transfer member, m represents mass of the one of the belt transfer member and the belt intermediate transfer member per unit length, L represents a length of the one of the belt transfer member and the belt intermediate transfer member between the two rollers or one of the two rollers and the tightener, z represents a number of gear teeth, s represents a rotation frequency of the gear per second, and n represents an order (or degree) number of a string vibration mode included in the transfer belt:
(n²T)/(2L²m)<z²S²
(n=1, 2, 3)

9. The rotation driving apparatus as claimed in claim 8, wherein a number of said roller state tightener is at least two, and wherein a string vibration occurrence frequency of the one of the belt transfer member and the belt intermediate transfer member is out of a visualization space frequency.

10. The rotation driving apparatus as claimed in claim 8, further comprising a tightener moving device configured to move the roller state tightener both in parallel and perpendicular to a belt stretching direction of the one of the belt transfer member and the belt intermediate transfer member.

11. The rotation driving apparatus as claimed in claim 10, further comprising:
a string vibration detection sensor configured to detect string vibration, said sensor being arranged in the vicinity of the surface of the one of the belt transfer member and the belt intermediate transfer member; and
a tightener moving control device configured to control the tightener moving device to move the roller state tightener in a prescribed position in accordance with a detection result of the string vibration detection sensor.

12. The rotation driving apparatus as claimed in claim 11, wherein said string vibration detection sensor includes a microphone.

13. A transfer apparatus configured to transfer and superimpose the different color images formed on the at least two image formation sections arranged side by side on the recording medium carried on one of the belt transfer member and the belt intermediate transfer member, said transfer apparatus comprising a rotation driving apparatus as claimed claim 8.

14. An image forming apparatus comprising:
at least two image formation sections arranged side by side and configured to form different color images, respectively; and
a transfer apparatus as claimed in claim 13.
